(19) United States
(12) Patent Application Publication
(10) Pub. No.: US 2008/0139099 A1
(43) Pub. Date: Jun. 12, 2008

(54) Compressor arrangement and air-conditioning system with compressor arrangement

(76) Inventor: Georg Baldauf, Lindenberg (DE)

Correspondence Address: DILWORTH & BARRESE, LLP, 333 EARLE OVINGTON BLVD., SUITE 702, UNIONDALE, NY, 11553, US

(21) Appl. No.: 11/982,827

(22) Filed: Nov. 5, 2007

(30) Foreign Application Priority Data
Nov. 6, 2006 (DE) 10 2006 052234.6

(51) Int. Cl. B64D 13/02; F04B 23/04; B64D 13/06

(52) U.S. Cl. 454/71; 417/426

(57) ABSTRACT

The present invention relates to a compressor arrangement with at least two compressors, wherein the compressor arrangement includes an intake chamber directly provided upstream of the at least two compressors together on the suction side.

### BACKGROUND OF THE INVENTION

The present invention relates to a compressor arrangement and an air-conditioning system with such a compressor arrangement.

Aircraft air-conditioning systems are known in a number of different embodiments. Electrically operated air-conditioning systems frequently include two or more than two compressors, which serve to deliver air through the air-conditioning system and provide the desired cabin pressure level. Known air-conditioning systems include an air duct upstream of the compressors, which includes a bifurcation from which individual partial ducts lead to the compressor inlets.

Such system known from the prior art is shown in FIG. 2, in which reference numeral 100 designates said bifurcation and reference numerals 200, 200′ designate the compressors, which suck in air to be compressed from the partial ducts 300, 300′. Such arrangement has the disadvantage that it requires comparatively much space, which is undesirable in particular in aircraft construction.

### SUMMARY OF THE INVENTION

Therefore, it is the object underlying the invention to improve a compressor arrangement with at least two compressors to the effect that the compressor arrangement has a compact design and provides for an aerodynamic flow to the compressors.

This object is solved by a compressor arrangement with the features herein. Accordingly, it is provided that the compressor arrangement includes an intake chamber directly provided upstream of the at least two compressors together on the suction side. In accordance with the invention, it is thus provided that the suction side of the two or more than two compressors is formed by a common intake chamber. Preferably, it is provided that the intake chamber is fed by a common air inlet duct. Via the air inlet duct, the air is delivered into the intake chamber and then flows from the intake chamber into the compressors mounted thereon, in which compression to the desired pressure level is effected.

The compressors preferably are aligned “against each other”, i.e. each withdraw air from the intake chamber in opposite directions.

In a further aspect of the invention it is provided that the intake chamber is configured as a rigid or also as a flexible structural part, which connects the two compressors with each other.

Furthermore, it is conceivable that further line connections can easily be provided on the intake chamber. This does not or only insignificantly impair the quality of the compressor inflow. Thus, the intake chamber can have one or more line connections or one or more lines connected to the intake chamber.

It is also conceivable that means for sound insulation are disposed in and/or on the intake chamber or are integrated in the intake chamber.

In a preferred aspect of the invention, the advantages of the compressor arrangement in accordance with the invention thus are as follows:
improved inflow of the compressors by free induction from the intake chamber,
compact, space-saving design,
simplified, inexpensive line system,
good adaptability of the shape of the chamber to specific construction problems,
further line connections easily adaptable to the intake chamber, without impairing the quality of the compressor inflow,
sound insulation measures to be integrated in an easy and space-saving way,
improved layout for the entire system (air-conditioning system).

In a further aspect of the invention it can be provided that the at least two compressors of the compressor arrangement run on axles aligned with each other or also on axles having an axial offset or an angular offset.

The present invention is not restricted to two compressors. Of course, more than two compressors are also conceivable, whose suction side is formed by the intake chamber.

The configuration of the compressors also can largely be chosen as desired. For instance, axial or radial compressors can be used.

In a further aspect of the invention, an intake funnel, i.e a specific advantageous intake geometry, is provided upstream of at least one of the compressors, preferably upstream of all compressors, in order to improve the compressor inflow.

The intake funnel(s) can form an integral part of the intake chamber, i.e. be configured as a component integral with the intake chamber.

It is likewise conceivable that the intake funnel(s) is/are configured as a component separate from the intake chamber, which is/are disposed between the intake chamber and the compressor. In this embodiment, the intake funnel(s), i.e. a component with a specific intake geometry, is/are configured as separate component(s), which is/are disposed between the intake chamber and the respective compressor.

The invention furthermore relates to an air-conditioning system, in particular an air-conditioning system for fresh-air supply, air-conditioning and pressurization of the aircraft cabin, which is characterized in that the air-conditioning system includes at least one compressor arrangement in accordance with the present invention.

It can be provided that the at least two compressors are each connected with a drive unit. The drive unit can be formed for instance by a motor and/or by a turbine. It is conceivable that the compressor arrangement includes two compressors, one of which is seated on a shaft together with a motor and a turbine or is driven by the same, and the other one of which is seated on a shaft together with a motor or is driven by the same.

The air-conditioning system preferably includes a control unit, by means of which the air-conditioning system can be operated in different operating modes. In a first operating mode, at least one of the compressors of the compressor arrangement is in operation, and in a second operating mode a larger number of compressors of the compressor arrangement is in operation as compared to the first operating mode. The operating mode selected depends on the pressure of the ambient air such that with a high pressure of the ambient air the first operating mode is set, and with a comparatively lower pressure of the ambienbt air, i.e. during flight or at a greater flight altitude, the second operating mode is set. In this way, it is possible to efficiently ensure pressurization, temperature control and fresh-air supply of an aircraft cabin independent of the flight altitude. In particular, it is thus possible to operate the compressors always within an optimum operating range or in the vicinity of an optimum operating point.

It is conceivable to mix the mass flows of the compressors in the second operating mode and then supply the same to the further treatment, i.e. for instance cooling and dehumidification, before the mixed air flow conditioned in this way is supplied to the aircraft cabin.

One embodiment of an air-conditioning system, in which the valve arrangement of the invention can be used, is disclosed in the German patent application DE 10 2005 037 285.6, which is fully incorporated herein by reference. The compressor arrangement of the invention can be used in one of the air-conditioning systems disclosed there, but the present invention also comprises the use of the compressor arrangement of the invention in any other air-conditioning system.

In a further aspect of the invention, the air-conditioning system includes first and second air-conditioners. Furthermore, two or more than two motorized compressors are provided, to which ambient air, ram air or precompressed air is supplied. In said second operating mode, a control unit activates at least one of the compressors of the compressor arrangement for both air conditioners. In a further operating mode, at least one of the compressors of the compressor arrangement is each activated for one of the two air conditioners. In this embodiment of the invention it is thus provided that the compressors can be activated step by step, which reduces the probability that the compressors of the air conditioners are operated in an unstable range.

The air-conditioning system can include an air inlet duct for guiding the air to the intake chamber, which has its own inlet or which has a common inlet with at least one further duct.

The air-conditioning system can include an air inlet duct for guiding the air to the intake chamber and/or a duct in which a ram air heat exchanger is disposed and/or a duct for motor cooling, wherein at least two or all of the ducts are combined to one common duct such that they have a common inlet.

Alternatively, it is conceivable that the air-conditioning system includes an air inlet duct for guiding the air to the intake chamber, which has its own inlet. In this aspect of the invention, further ducts, such as the ram air duct and/or the duct for motor cooling, are configured as ducts separate from the air inlet duct, which have an inlet different from the air inlet duct.

### BRIEF DESCRIPTION OF THE DRAWINGS

Further details and advantages of the invention are illustrated with reference to an embodiment shown in the drawing, in which:

FIG. 1a: shows a schematic representation of the compressor unit of the invention,

FIG. 1b: shows a perspective view of an air-conditioning system of the inveniton with the compressor unit of the invention,

FIG. 2: shows an arrangement of two compressors with bifurcated suction air line in accordance with the prior art,

FIG. 3: shows a schematic representation of an aircraft air-conditioning system of the invention, and

FIG. 4: shows a schematic representation of an aircraft air-conditioning system of the invention in a further embodiment.

### DESCRIPTION OF THE PREFERRED EMBODIMENTS

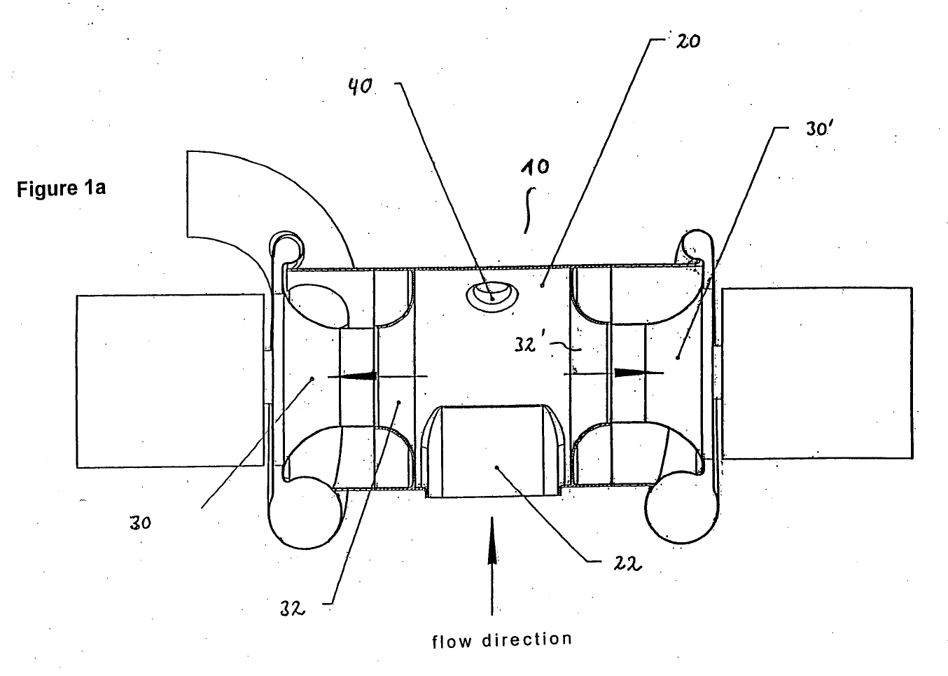

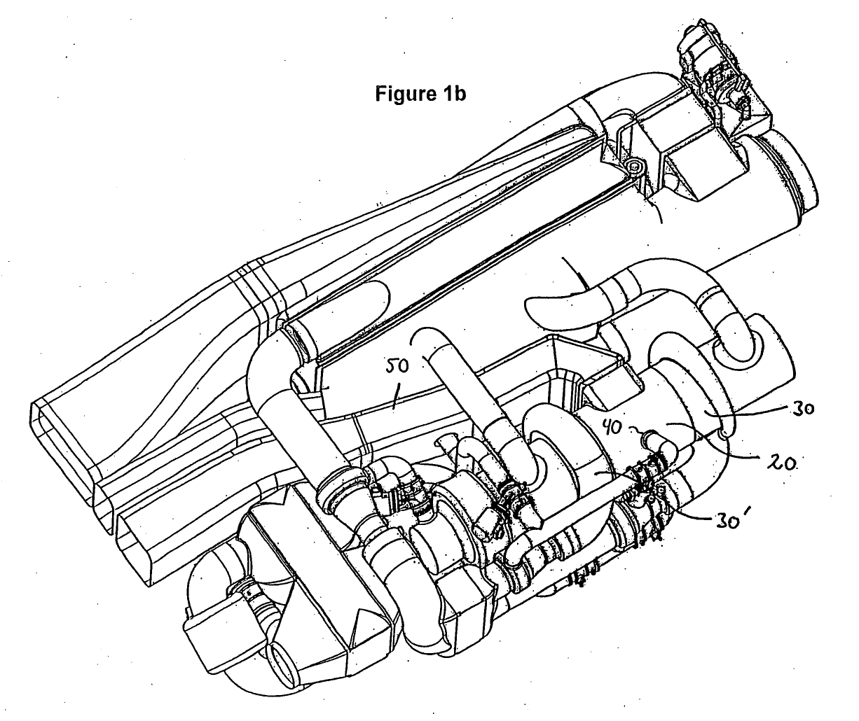

FIG. 1a shows the compressor arrangement 10 of the invention, which consists of a centrally disposed intake chamber 20 and two radial compressors 30, 30′ disposed on both sides of the intake chamber 20. The opposed compressors 30, 30′ are rotatable about axles aligned with each other. The compressors 30, 30′ are arranged such that their suction side is formed by the intake chamber 20, which is located between the compressors 30, 30′.

Reference numeral 22 designates the inlet of the intake chamber, through which air flows into the intake chamber 20 preferably from a common air inlet duct.

Reference numerals 32, 32′ designate the inlets of the compressors 30, 30′, and reference numeral 40 designates an optional connection of the intake chamber 20, to which any other line connection can easily be connected without the flow conditions in the intake chamber 20 changing considerably.

As is indicated by the arrows in FIG. 1a, the two compressors 30, 30′ are aligned in opposite directions, i.e. they withdraw air on both sides of the intake chamber 20. The compressors 30, 30′ each can be power-operated. It is also conceivable that one or both compressors 30, 30′ together with a turbine are seated on a shaft which drives the compressor(s) 30, 30′.

A major advantage of the compressor arrangement 10 of the invention as shown in FIG. 1a consists in that the same has a compact design due to the presence of the common intake chamber 20 and in addition ensures favorable flow conditions on the suction side of the compressors 30, 30′.

FIG. 1b shows the integration of the compressor arrangement 10 of FIG. 1 in an air-conditioning system in accordance with the present invention, identical parts being provided with identical reference numerals. In addition to FIG. 1a, FIG. 1b shows the air inlet duct 50, which is connected with the inlet 22 of the intake chamber 20 and delivers the air to be compressed into the intake chamber 20.

The air inlet duct 50 can have its own inlet and can thus be configured as a duct separate from other air ducts, such as the ram air duct or the air duct for cooling the motors. It is conceivable that each of said ducts has its own inlet.

The invention furthermore comprises an arrangement in which apart from the air inlet duct a ram air duct, in which the RAM heat exchanger is provided, and/or a duct for motor cooling are provided, wherein at least two or all of said ducts are combined to one common duct such that they have a common inlet. Downstream of the inlet, the common duct branches at a suitable position to said components of the air-conditioning system.

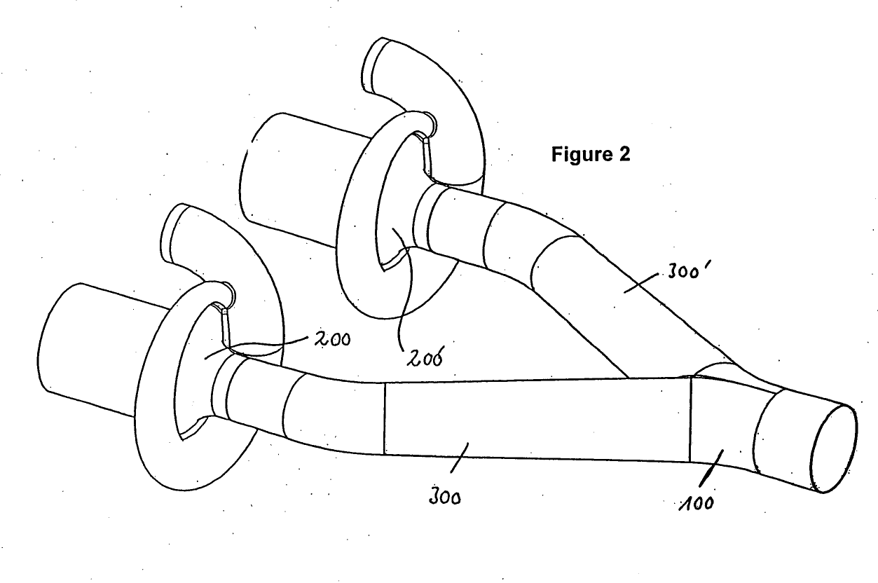

FIG. 2 shows an arrangement in accordance with the prior art and illustrates that there is provided a bifurcation 100, from which individual intake lines 300, 300′ extend to the compressors 200, 200′, whereby a comparatively large-size arrangement is obtained.

As stated above, a compact and aerodynamic arrangement can be provided by the compressor arrangement of the invention, which furthermore involves the advantage that a simplified and inexpensive line system can be realized.

The compressor arrangement of the invention can be used not only, but advantageously in an air-conditioning system as it is known from DE 10 2005 037 285.6, which is fully incorporated herein by reference.

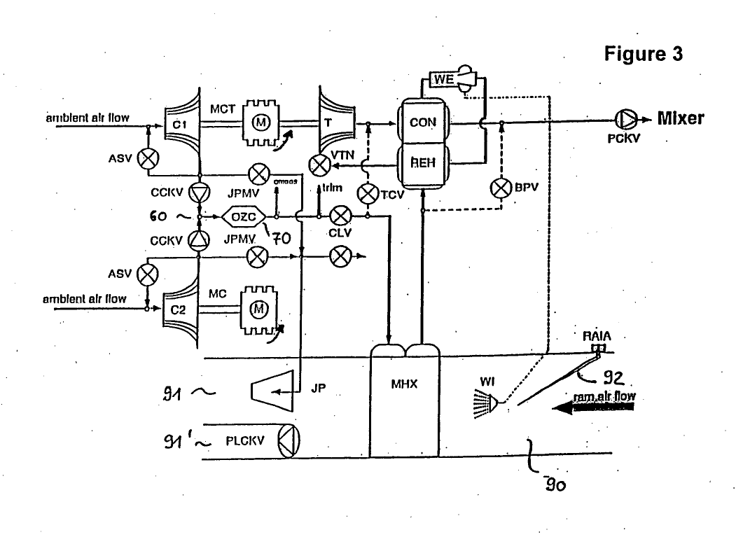

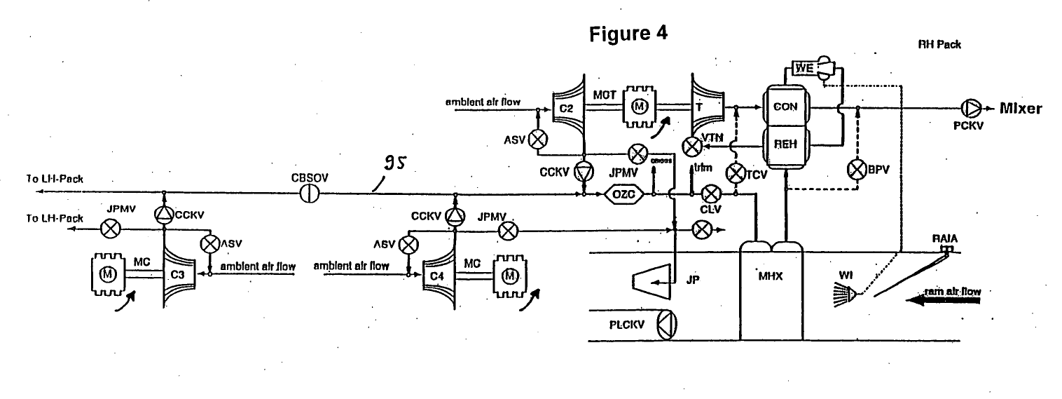

An air-conditioning system known from this reference is shown in FIG. 3. Reference numeral C1 in FIG. 3 designates a first compressor supplied with ambient air. The same is connected with a motor M and an expansion turbine T on a shaft. The entire unit is referred to as MCT (motorized compressor turbine). The curved arrow in the vicinity of the motor M should indicate the cooling thereof for instance by means of a jet pump or a blower, which can be arranged e.g. in the ram air duct. The same is true for the arrangement as shown in FIG. 4.

Beside this compressed-air source, a further compressed-air source is provided in the form of the compressor C2 connected in parallel, which is switched on or off depending on the operating mode in which the system is operated. This further compressed-air source can be switched on or off or also be partly switched on by means of a valve. The second compressor C2 likewise is a motorized compressor supplied with ambient air, as is shown in FIG. 3.

The check valves CCKV ensure that the flow of the respective outlet lines does not lead to the respective compressor C1 or C2.

The outlet lines of the compressor C1 and of the compressor C2 are connected with each other in a mixing point 60. Downstream of this mixing point 60 a chamber 70 is located, in which for instance a converter for ozone and/or for hydrocarbons (OZC) can be disposed. Downstream of this chamber, the ram air heat exchanger MHX is located, which is disposed in the ram air duct 90 of the aircraft, as is shown in FIG. 3. On its outlet side, the ram air heat exchanger MHX is connected with a water separation circuit consisting of reheater REH, condenser CON and water separator WE, the components being arranged in the sequence of reheater, condenser and water separator. On its outlet side, the water separator WE is connected with the cold side of the reheater REH. On the outlet side, the cold side of the reheater is connected with the turbine T via a distributor VTN (Variable Turbine Nozzle), which is provided upstream of the turbine T. The cold turbine outlet air flows through the condenser CON on its cold side, and upon passing a check valve PCKV (Pack Check Valve) then is supplied to a mixing chamber or to the aircraft cabin.

The water separated in the water separator WE is supplied to the ram air duct 90 via a water injector WI, as is shown in FIG. 3. On the inlet side of the ram air duct, a ram air duct inlet valve 92 is located, which can be moved in different positions by means of the RAIA (Ram Air Inlet Actuator).

On the ram air side downstream of the ram air duct heat exchanger MHX, the ram air duct is divided into two portions 91 and 91′. In the portion shown at the top, the jet pump JP is located, which is connected with the outlet lines of the compressors C1, C2 via valves JPMV (Jet Pump Modulating Valve).

Downstream of the chamber 70 and upstream of the ram air duct heat exchanger MHX, a line extends from the mixed air line to the outlet side of the turbine T, in which a valve TCV (Temperature Control Valve) is disposed. Furthermore, a bypass line is provided, which extends from the outlet side of the ram air duct heat exchanger MHX to the line of the air-conditioning system leading to the mixing chamber. This line includes the valve BPV (Bypass Valve).

As is furthermore shown in FIG. 3, the second compressor C2 is driven by a motor M. A turbine is not provided here, so that the arrangement MC (motorized compressor) is obtained. For the compressors C1 and C2, recirculation lines are illustrated, which can be closed by a valve ASV (anti-surge valve). Furthermore, a further valve CLV (compressor load valve) is provided in the line extending from the chamber 20 to the ram air duct heat exchanger MHX. The valve CLV serves to throttle the compressors C1, C1, by means of which the outlet temperature of the compressors C1, C2 is increased.

By opening the valve ASV, the recirculation air flowing over the compressors can be increased, which provides for a safe and stable operation of the compressors C1, C2. Increasing the compressor mass flow can also be realized via the jet pump modulating valves JPMV.

The compressors C1, C2 can form part of the compressor arrangement 10 as shown in FIGS. 1a and 1b (not shown in FIGS. 3 and 4), i.e. withdraw air from a common intake chamber, which forms the common suction side of the compressors C1, C2, and compress the same to the desired pressure level. In one embodiment, the recirculation lines described above in detail, in which the valve ASV is disposed, also can open into this intake chamber.

The operation of the arrangement as shown in FIG. 3 is as follows:

In a first operating mode, the entire fresh air is only provided by the compressor C1. The same preferably has a one-stage design, but a multistage design also can be considered in principle. This is also true for the compressor C2.

The compressor C1 serves to meet the requirements as regards pressurization, temperature control and fresh-air supply. Upon passing the chamber 70, the compressor outlet air first is cooled in the ram air duct heat exchanger MHX. Subsequently, this air flows through the water separation circuit and then is subjected to a second cooling in the single turbine T in the cooling process. The turbine power together with the power of the motor M serves to drive the compressor C1. The cold turbine outlet air serves for condensation of the humidity of the outlet air of the ram air duct heat exchanger in the condenser CON.

In the second operating mode, the compressor C2 is activated, i.e. the fresh-air mass flow now is formed by the outlet air of both compressors C1, C2. In the second operating mode, the mixed air flow now flows through the same components as the outlet air of the compressor C1 in the first operating mode.

In a third operating mode, it can be provided that providing the fresh air initially is effected like in the second operating mode. However, the water separation circuit and the turbine stage now can at least partly be bypassed by opening the valve BPV due to the ambient conditions at a great flight altitude. Cooling in the third operating mode now substantially is effected by means of the ram air duct heat exchanger MHX.

The number of utilized compressors C1, C2 is not fixed in principle. For covering the entire field of use, there is preferably effected a parallel connection of at least two compressed-air sources, i.e compressors C1, C2, per pack (air conditioner), which can form part of the compressor arrangement of the invention.

As is furthermore shown in FIG. 3, the second compressor C2 can be used to operate the jet pump JP when the valve JPMV is open. This leads to the fact that a cooling air flow over the ram air heat exchanger(s) is also ensured in the first operating mode. As can furthermore be taken from FIG. 3, the compressor outlet air of the compressor C1 can be supplied to the jet pump via a valve JPMV. Such procedure is particularly expedient to provide for a safe and stable operation of the compressor C1. As a result, the additional mass flow is passed into the ram air duct via the jet pump JP or can alternatively be supplied to further loads.

To increase the transmittance of the air conditioner, the cross-sectional area can optimally be adjusted via a variable turbine distributor. For this purpose, the unit VTN of the turbine T is used. This unit can be actuated with the valve TCV, which is used for temperature control, by means of a common actuator.

FIG. 4 shows a further variant of an air conditioner operated by the method of the invention. For ground operation and low flight altitudes, the air conditioner is operated as explained with reference to FIG. 3. The arrangement as shown in FIG. 4 provides for activating step by step the motorized compressors C3 and C4 supplied with ambient air, which reduces the probability that the compressors C1 and C2 of the right-hand or left-hand pack (air conditioner) are operated in the unstable range.

In accordance with FIG. 4, it is provided that from a certain flight altitude, only one of the additional compressors C3 or C4 is operated in parallel to the compressors of the LH and RH pack. The consequence is that the reduction of the mass flows for the first compressors C1 and C2 is not effected so strongly and an operating point within the stable range (to the right of the pumping limit/surge line) remains possible. To distribute the mass flow of the activated compressor (C3 or C4) over both packs, the same are connected with each other via a line 95 (Cross Bleed Ducting). In this line, the valve CBSOV (Cross Bleed Shut Off Valve) is disposed, by means of which line 95 can be opened or closed.

The connection of the two air conditioners by cross bleed ducting leads to a redundant configuration, as each of the air conditioners can be connected with compressed-air sources associated to the other air conditioner, if necessary.

At a greater flight altitude, the further additional compressor (C3 or C4) now can also be activated in parallel. The valve CBSOV is closed, so that again two separate packs are operated with the second operating mode as shown in FIG. 3.

The compressors C3 and C4 likewise can form part of a compressor arrangement in accordance with the invention, i.e. have a common intake chamber, which constitutes the suction side of the two compressors C3, C4.

As explained above, the use of the compressor arrangement in accordance with the invention is not restricted to electrically operated air-conditioning systems or to air-conditioning systems as shown in FIGS. 3 and 4. The compressor arrangement of the invention also can advantageously be used in air-conditioning systems designed differently or operating in a different way.

1. A compressor arrangement with at least two compressors, wherein the compressor arrangement includes an intake chamber directly provided upstream of the at least two compressors on the suction side.

2. The compressor arrangement according to claim 1, wherein the at least two compressors are directed against each other.

3. The compressor arrangement according to claim 1, wherein for the at least two compressors a common air inlet duct is provided, which opens into the intake chamber.

4. The compressor arrangement according to claim 1, wherein the intake chamber is configured as a rigid or flexible structural part, which connects the at least two compressors with each other.

5. The compressor arrangement according to claim 1, wherein the intake chamber includes one or more line connections or one or more lines connected to the intake chamber.

6. The compressor arrangement according to claim 1, wherein means for sound insulation are disposed in and/or on the intake chamber or are integrated in the intake chamber.

7. The compressor arrangement according to claim 1, wherein that the at least two compressors run on axles which are aligned with each other.

8. The compressor arrangement according to claim 1, wherein the at least two compressors run on axles which have an axial offset or an angular offset.

9. The compressor arrangement according to claim 1, wherein the at least two compressors are axial or radial compressors.

10. The compressor arrangement according to claim 1, wherein an intake funnel for improving inflow to the compressors is provided upstream of at least one of the compressors, preferably upstream of all compressors.

11. The compressor arrangement according to claim 10, wherein the intake funnel(s) is/are an integral part of the intake chamber.

12. The compressor arrangement according to claim 10, wherein the intake funnel(s) is/are configured as a component separate from the intake chamber, which is/are arranged between the intake chamber and the compressor.

13. An air-conditioning system, in particular an air-conditioning system for fresh-air supply, air-conditioning and pressurization an aircraft cabin, wherein the air-conditioning system includes at least one compressor arrangement according to claim 1.

14. The air-conditioning system according to claim 13, wherein a control unit is provided, by which the air-conditioning system can be operated in a first operating mode and in a second operating mode, in the first operating mode at least one compressor of the compressor arrangement is in operation, in the second operating mode a larger number of compressors of the compressor arrangement is in operation as compared to the first operating mode, and the operating mode selected depends on the pressure of the ambient air such that with a high pressure of the ambient air the first operating mode is set and with a comparatively lower pressure of the ambient air the second operating mode is set.

15. The air-conditioning system according to claim 13, wherein the air-conditioning system includes first and second air conditioners and furthermore two or more than two motorized compressors supplied with ambient air, ram air or precompressed air, which form part of the compressor arrangement, furthermore a control unit is provided, which in the second operating mode activates at least one of the compressors of the compressor arrangement for both air conditioners, and which in a further operating mode each activates one or more than one of the compressors of the compressor arrangement for the first and second air conditioners.

16. The air-conditioning system according to claim 13, wherein the air-conditioning system includes an air inlet duct by means of which air is guided to the intake chamber, wherein the air inlet duct has its own inlet associated only to the air inlet duct or an inlet in common with at least one further duct.

17. The air-conditioning system according to claim 16, wherein the air-conditioning system includes an air inlet duct for guiding the air to the intake chamber and/or a duct in which a ram air heat exchanger is disposed and/or a duct for motor cooling, at least two or all of the ducts are combined to one common duct such that they have a common inlet.

18. The air-conditioning system according to claim 16, wherein the air-conditioning system includes an air inlet duct for guiding the air to the intake chamber and/or a duct in which a ram air heat exchanger is disposed and/or a duct for motor cooling, at least two or each of the ducts are configured as a separate duct with a separate inlet each.

19. The compressor arrangement according to claim 2, wherein for the at least two compressors a common air inlet duct is provided, which opens into the intake chamber.

20. The compressor arrangement according to claim 19, wherein the intake chamber is configured as a rigid or flexible structural part, which connects the at least two compressors with each other.
